(19) United States
(12) Patent Application Publication
(10) Pub. No.: US 2012/0254787 A1
(43) Pub. Date: Oct. 4, 2012

(54) Method and system for accessing data

(76) Inventor: Dusan Toman, Hlohovec (SK)

(21) Appl. No.: 13/065,728

(22) Filed: Mar. 29, 2011

(51) Int. Cl. G06F 3/048

(52) U.S. Cl. 715/777

(57) ABSTRACT

A user interface tool for use on a user display comprising a central display box for displaying information relating to some or all of a data set based on the user's selections, a plurality of tabs corresponding to portions of the data set positioned adjacent to the central display box, whereby information relating to the portion of the data set corresponding to that tab is displayed in the central display box when one of the tabs is selected by the user; and whereby the user can transfer the portion of the data set corresponding to the selected tab to a target graphic on the user display.

### BACKGROUND OF THE INVENTION

1. Field of the Invention

The invention relates generally to the field of methods and systems for accessing structured data maintained in a digital database. In particular, the invention relates to a digital user interface tool for the display of information contained in such a database.

2. Description of Related Art

People work with all types of data and are used to organizing, using, and displaying data in certain types of data sets. Historically, people have commonly used a format generally referred to as a spreadsheet or data table to organize and display data sets in a useful way. A spreadsheet is a table with rows and columns containing the data that forms the data set. The first row of the spreadsheet typically is a header row containing the names or descriptions of the content of the various columns that make up the spreadsheet. Subsequent rows typically contain the data records that form the data set that is displayed in the spreadsheet. Before digital computers became common, spreadsheets were printed on paper and there are even examples of early spreadsheets carved in stone tablets. Modern spreadsheets are typically produced by computer programs that are capable of displaying data in a variety of different spreadsheet layouts.

Users of the information contained in a database often need to analyze the data records, creating and adjusting data models to draw out information from those data records. Some or all of the results of such data analysis often then must be presented visually, both as part of the analytical process itself and for purposes of presenting the results of the analysis. Results are often presented in complex data charts that take a wide variety of forms. Modern data analysts are often presented with extremely rich data sets that can be displayed using a wide range of different kinds of data charts.

To efficiently perform such modern data analysis on computerized databases, analysts need a user interface that allows them to quickly and easily access and use specific data records. The prior art includes graphical database user interface tools that allow users of database software to access data and display that data on a screen to the user. Such prior art database programs provide users with some ability to access selected data and display it in one or more formats. For example, common spreadsheet applications such as MICROSOFT EXCEL allow users to select data contained in the database represented on displayed worksheets and move that data to different worksheets or display that data in a different format.

Prior art user interface tools, however, use traditional formats such as windows containing text lists, scrolling lists, list-encapsulated buttons, tree-view lists and other common hierarchical structures. These user interfaces often make it difficult to work effectively on complex data sets requiring sophisticated analysis.

It can be seen that fast, easy access to specific components of the data in such databases is essential to effective data analysis. Prior art systems, however, have failed to provide users with a simple, intuitive way to quickly and easily select a wide range of specific data components and display them in a variety of forms on the screen. The present invention overcomes this failure, providing a simple method and system for accessing specific components of a data source and displaying those components to the user in a wide variety of formats.

### SUMMARY OF THE INVENTION

A user interface tool for use on a user display comprising a central display box for displaying information relating to some or all of a data set based on the user's selections and a plurality of tabs corresponding to portions of the data set positioned adjacent to the central display box, whereby information relating to the portion of the data set corresponding to that tab is displayed in the central display box when one of the tabs is selected by the user, and whereby the user can transfer the portion of the data set corresponding to the selected tab to a target graphic on the user display. In various exemplary embodiments, the plurality of tabs includes tabs corresponding to the columns of data in the data set, the rows of data in the data set, a user defined portion of the data set, and/or a pre-defined portion of data in the data set.

In various exemplary embodiments, the tabs are labeled to identify the corresponding portion of the data set, and/or may include tabs corresponding to the dimensions of a multidimensional database, tabs corresponding to the measures of a multidimensional database, or tabs corresponding to hierarchies of data in a multidimensional database. In an exemplary embodiment, the hierarchies of multidimensional data are displayed in the central display box and the user can select from the hierarchies displayed in the central display box. In various exemplary embodiments, the target graphic is a chart, a graph, a spreadsheet, a database report, a database development tool, or a database management tool. In various exemplary embodiments, the position of the tabs is based on the logical disposition of data tables and spreadsheets, and the user can identify a portion of a dataset further used in an application by selecting its associated tab.

### BRIEF DESCRIPTION OF THE DRAWINGS

FIG. 1 is a diagram showing an exemplary embodiment of a user interface tool window.

FIG. 2 is a diagram showing an exemplary embodiment of a user interface tool window.

FIG. 3 is a diagram showing an exemplary embodiment of a user interface tool window.

FIG. 4 is a diagram showing a computer screen displaying an exemplary embodiment of a user interface tool window and target graphics.

FIG. 5 is a diagram showing an exemplary embodiment of a user interface tool window.

FIG. 6 is a diagram showing an exemplary embodiment of a user interface tool window.

FIG. 7 is a diagram showing an exemplary embodiment of a user interface tool window.

FIG. 8 is a diagram showing an exemplary embodiment of a user interface tool window.

FIG. 9 is a diagram showing an exemplary embodiment of a user interface tool window.

FIG. 10 is a diagram showing an exemplary embodiment of a user interface tool window.

FIG. 11 is a diagram showing an exemplary embodiment of a user interface tool window.

FIG. 12 is a diagram showing an exemplary embodiment of a user interface tool window.

FIG. 13 is a diagram showing an exemplary embodiment of multiple user interface tool windows.

FIG. 14 is a diagram showing an exemplary embodiment of multiple user interface tool windows.

FIG. 15 is a diagram showing an exemplary embodiment of a user interface tool window.

FIG. 16 is a diagram showing an exemplary embodiment of a hardware system that can be used with the disclosed user interface tool window concept.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

The user interface tool described here is a graphical component of the user interface—typically a display device used together with a computer or computer network—and a set of rules and conventions that define how the user interface tool interacts with a user. It overcomes limitations of user interfaces commonly used for database development, management, maintenance, reporting, business intelligence, analytics, charting, and visualization systems to enhance the user experience and improve efficiency of the processes. Conceptually, the user interface tool is based on how people imagine data and allows users to easily select a wide range of data sets and sub-sets, then use and display those data sets in a wide range of settings and applications to better understand all of the various database components.

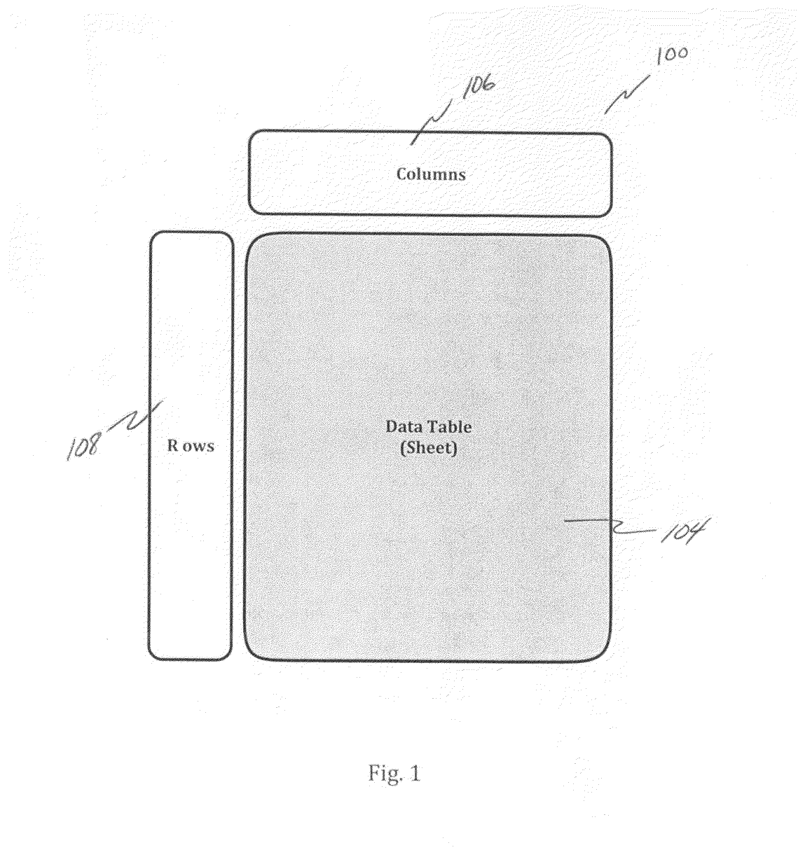

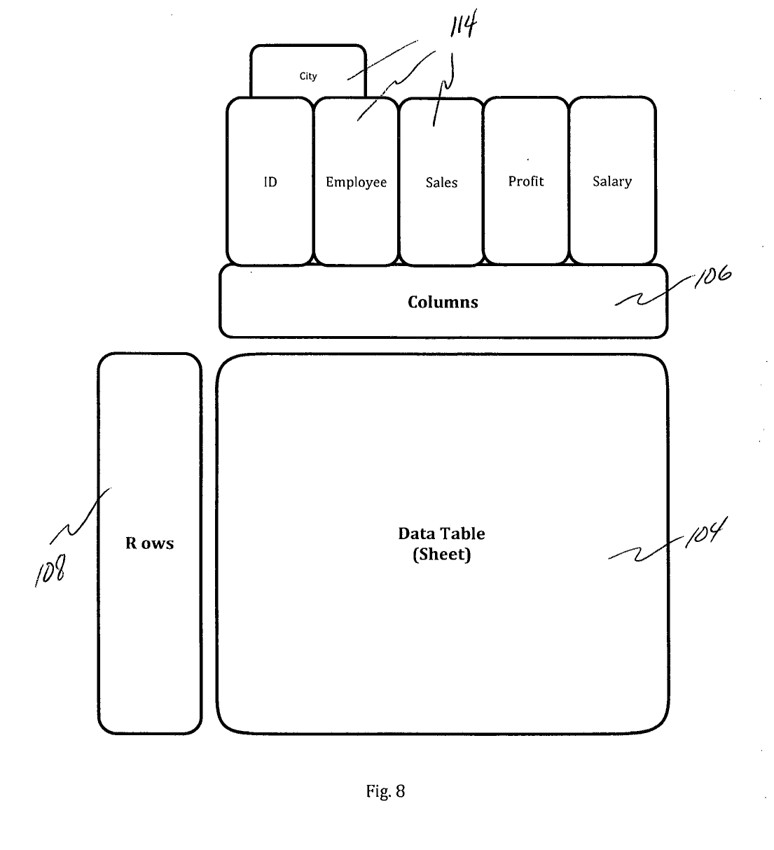

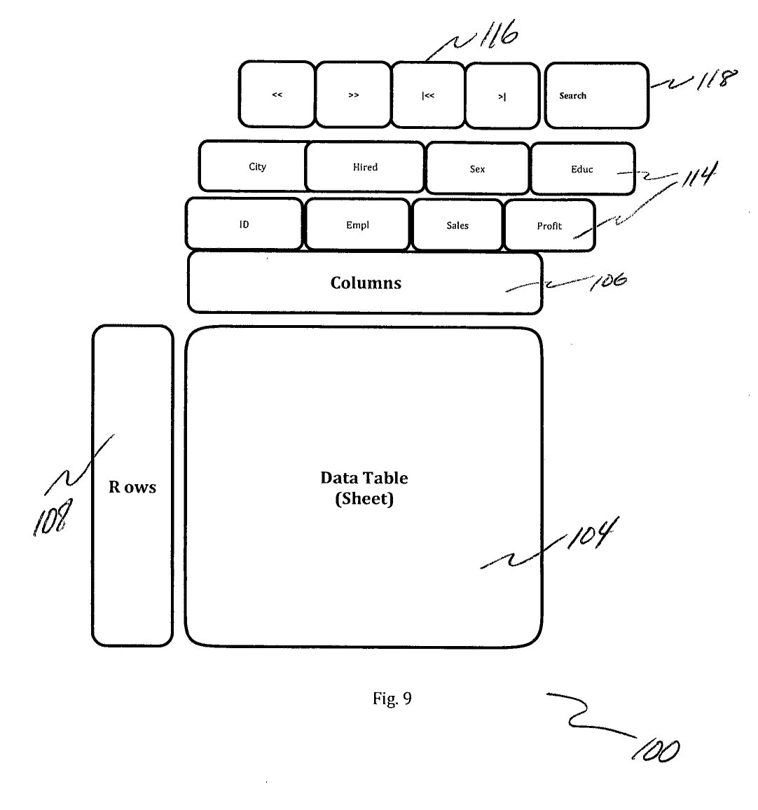

Referring generally to FIGS. 1 through 12, an exemplary embodiment of the invention consists of a digital user interface tool 100 that is displayed to the user on their display screen 102 as a window that can be moved to any location on the user's display screen. Such a user interface tool 100 may be used to enhance the display of data using any commonly available or any customized database software, such as Excel, Oracle, SQL Server, MySQL, DB2, SAP or any other analytical database, data warehouse or spreadsheet.

The user interface tool 100 includes a central display box 104 that displays to the user information based on the user's selections. In its initial state the central display box 104 may display a data table or “sheet” or may serve as a dialog box or otherwise provide information about the subject database or the user interface tool 100 itself. One or more column tabs 106 or buttons relating to data sets stored in “columns” may be positioned above or below the central display box, and one or more row tabs 108 or buttons relating to data sets stored in “rows” may be positioned to the left or right of the central display box. These tabs 106, 108 may be labeled with any appropriate text or images indicating the nature of the data sets they can be used to access or manipulate.

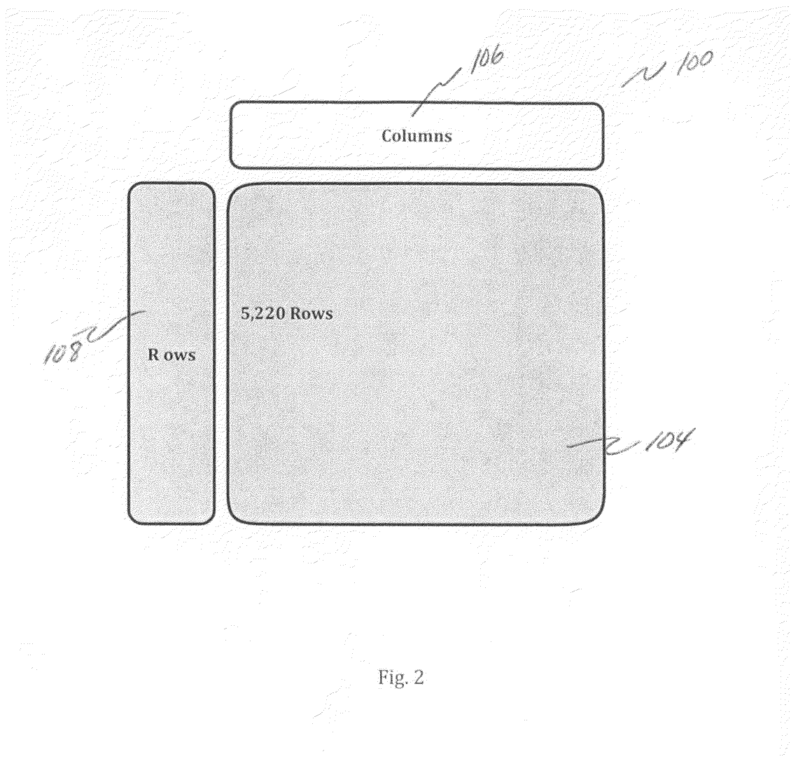

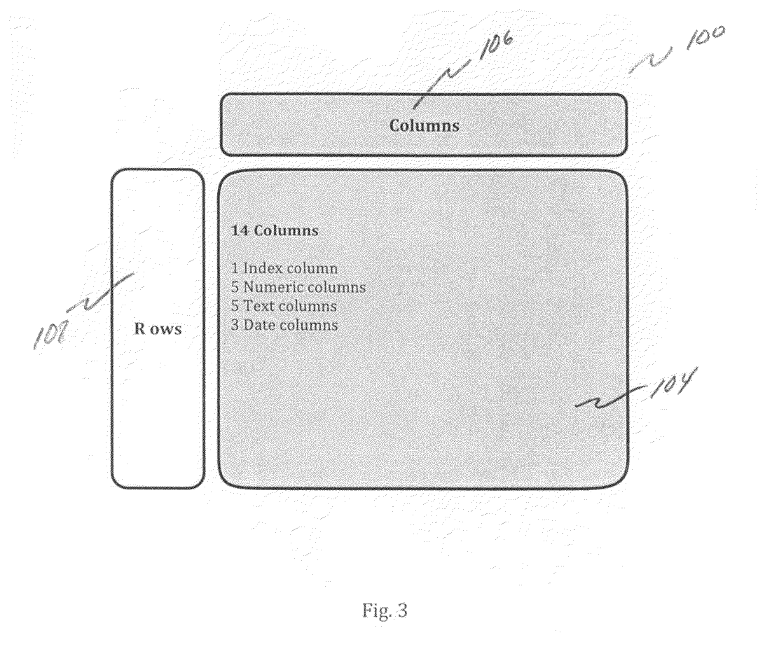

In order to access the data sets contained in the subject database, the user can use a pointing device such as a mouse cursor, tablet, finger, eye-tracking, body-tracking, mind-monitoring or any other available means to select one of the tabs 106, 108. As seen in FIGS. 2 and 3, the data interface tool may respond by changing its state to visually identify the selected data set. For example, as shown in FIG. 2, if a user selects the “Rows” data set a visual indicator is provided to the user such as by shading the selected tab gray, changing the selected tab's color or brightness, adjusting its transparency, or switching to a blinking state.

Based on the user's selection, the central display box 104 will then display information related to the selected data set. In the example illustrated in FIG. 2, for the data set “Rows” these details may include total number of rows as well as basic statistical values like min/max values, mean, standard deviation etc. In the example illustrated in FIG. 3, selection of the “Columns” data set causes the central display box to provide information regarding the “Columns” data set such as a total number of columns, number of text columns, number of numerical columns, number of date or time columns, etc. The specific information displayed to the user regarding the selected data set can be tailored to the type of data or anticipated users.

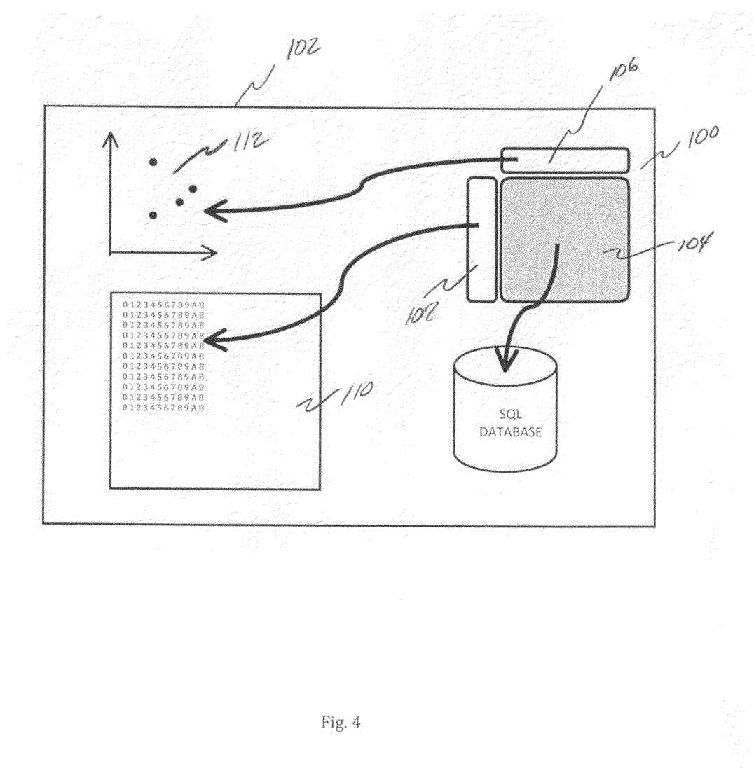

As seen in FIG. 4, the user interface tool 100 window will typically be displayed on the user's screen together with a target graphic on the primary display area such as a chart 110, graph 112, document, report, database development, database service or maintenance, database query-making tool, or spreadsheet. The user interface tool may be used to drag-and-drop a selected set or all of the database information into the target graphic.

For example, the user can select an entire data sheet and keep all the information on data points including values, data types, columns and rows ordering, available for further use or further data processing. Dropping this selected data sheet on a target graphic will copy all the information in the selected data sheet to the target graphic, where it can be integrated into the target graphic and seen by the user. Thus, if the selected data sheet is dropped into a chart 110, the system could place the entire selected data sheet into the chart, keeping the same positioning of data points by columns and rows as in the original data source and mapping data values to a graphical attribute used by the particular chart 110 on the primary display area such as size or color. If the target graphic is not a chart, but rather is a query-making, database-maintenance, or calculation module, the database application will process the dropped information from the data sheet to deploy as much as data sheet-related information as possible.

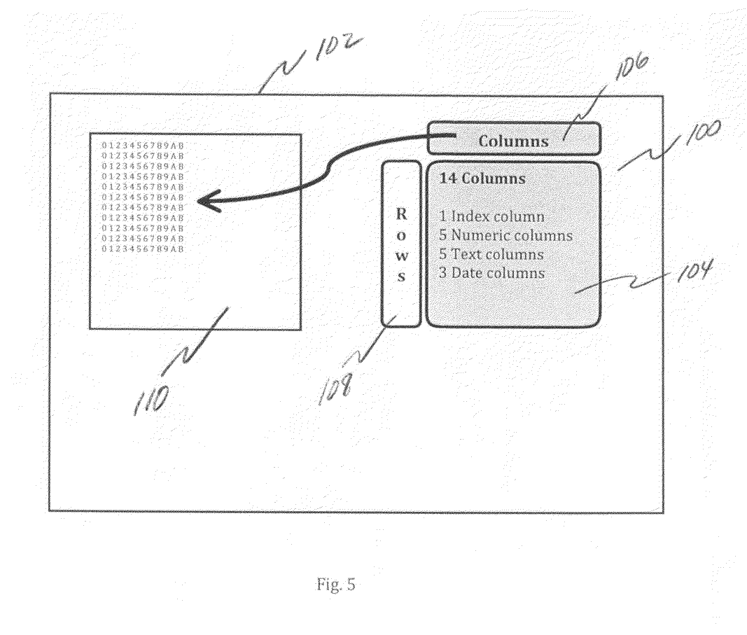

As shown in FIG. 5, the same process can be used to drag and drop the data set represented in the “Columns” tab 106 of the user interface tool 100. When a user drags the “Columns” data set and drops it on a target graphic in the primary display area, all of the “Columns,” including data types and ordering information, will be integrated into the target graphic to deploy as much “Columns”-related information as possible.

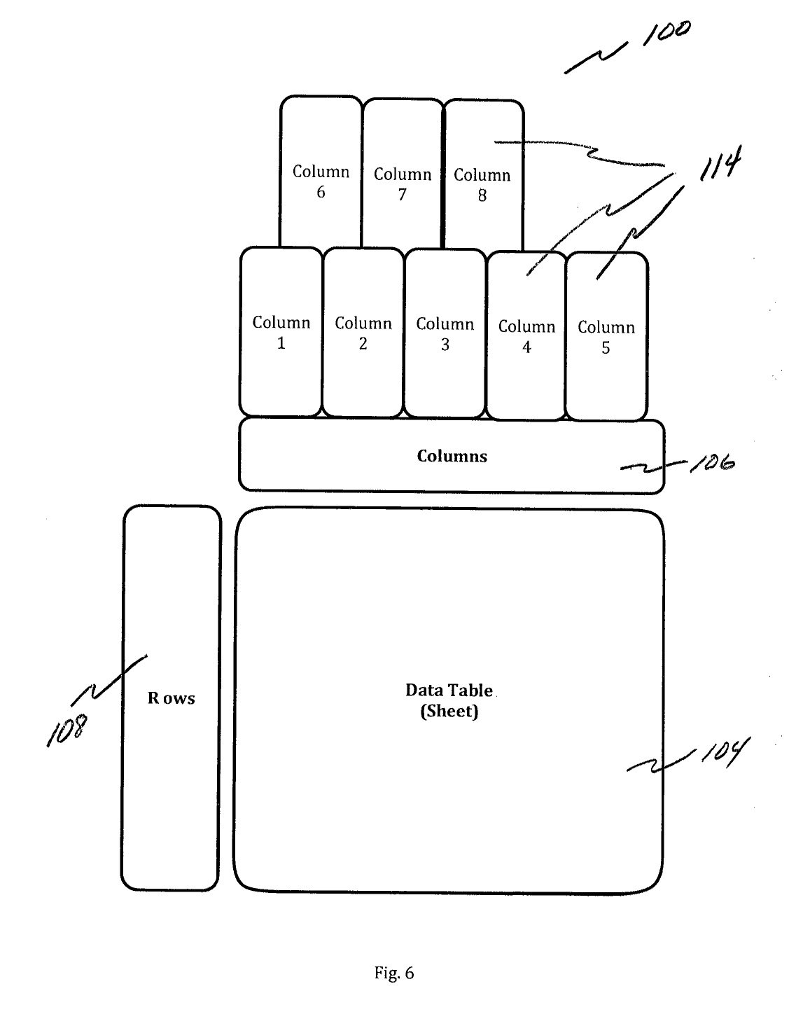

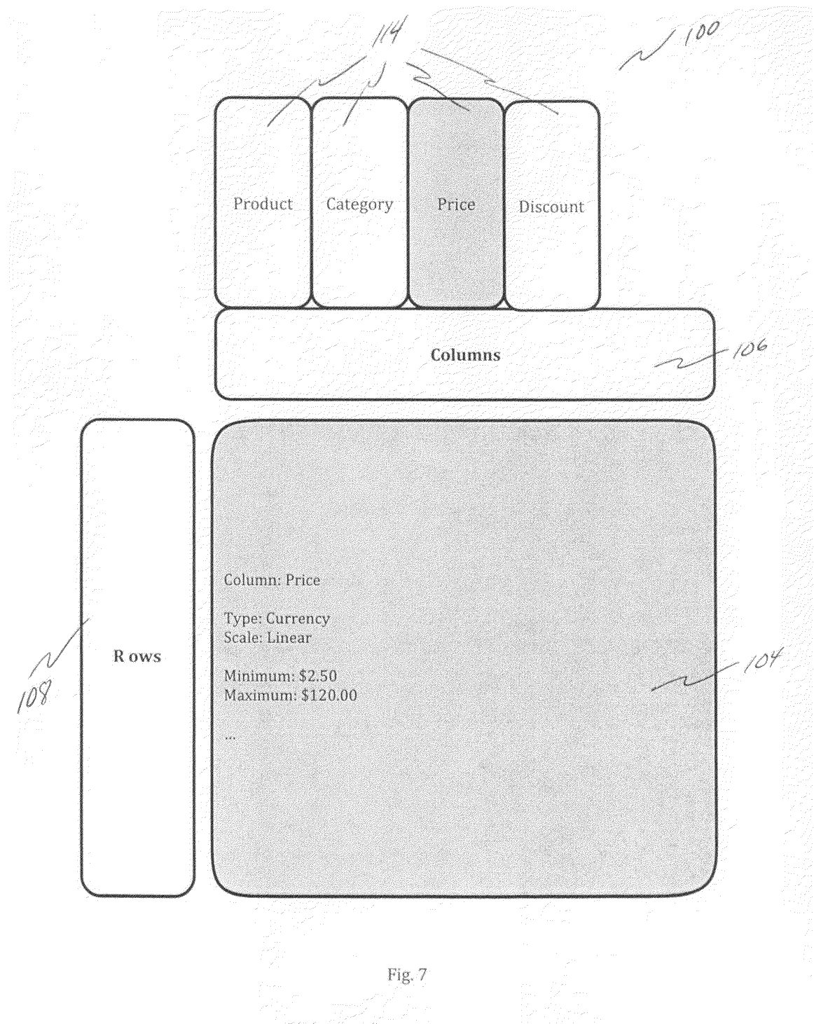

Multiple tabs 114 can also be used in the user interface tool to allow the user to obtain quick access not to an entire data sheet or set of columns, but to just one specific column or other data set. Referring to FIGS. 6 and 7, in an exemplary embodiment of the invention, multiple tabs 114 representing each different column of data in the database can be added to the user interface tool 100. For ease of use, these additional tabs 114 may be labeled with original column names and positioned and ordered accordingly to the real positions of the columns in the database. If a data set does not provide column names (i.e. header row is missing), labels like “Column 1”, “Column 2”, until “Column N” (N is the number of the last column), or similar formatting may be used to provide for easier navigation and orientation.

Referring to FIGS. 6 through 12, if the data sheet contains too many columns and there is not enough room for displaying all the available columns comfortably in tabs above the central display box, the system can display column tabs vertically, or rotated by 90 degrees, or using a smaller font. If the total number of column tabs is very large it may be useful to limit the total number of lines of column tabs that are displayed and provide a set of control tabs 116 or buttons for browsing to the next/previous line of column tabs, and if necessary also a support for browsing to the first and last column line. When working with complex, high-dimensionality data sets containing a very large number of columns (several dozens, hundreds or more), the system may include a search function 118 for providing access to columns matching the search criteria. In this mode, the user interface tool may only display the columns that fit the search substring and may hide the rest of the columns.

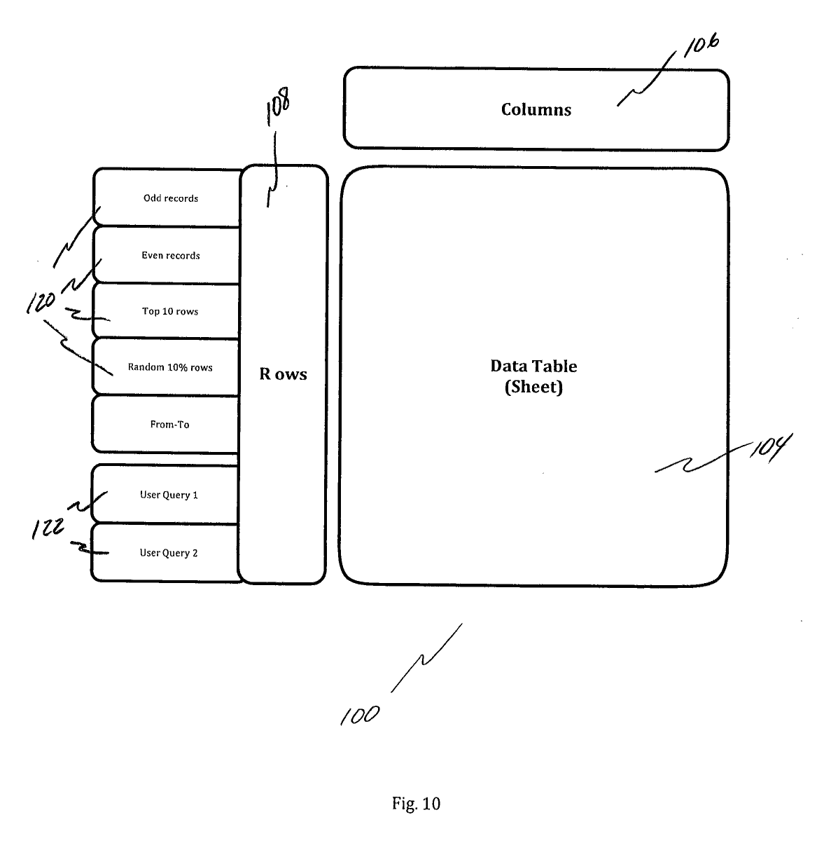

When a user is working with large databases consisting of many rows, it may be useful to have access to particular data sets or predefined queries using function tabs 120. Referring to FIG. 10, examples of such useful data sets might include “Odd/Even rows”, “Top 10 rows”, “From-To-Step rows”, “Random 10% rows” and similar often used data sets. User defined queries may also be created and provided in dedicated tabs 122. These data sets can be dragged and dropped in the same way as other pre-defined data sets as described above.

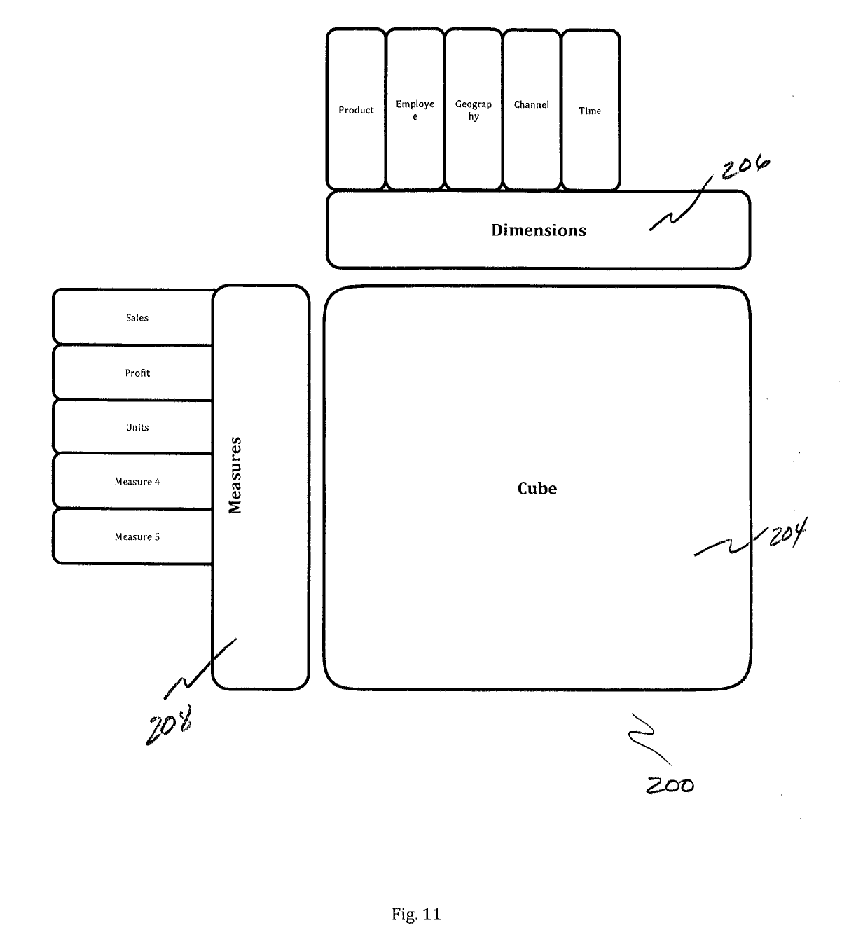

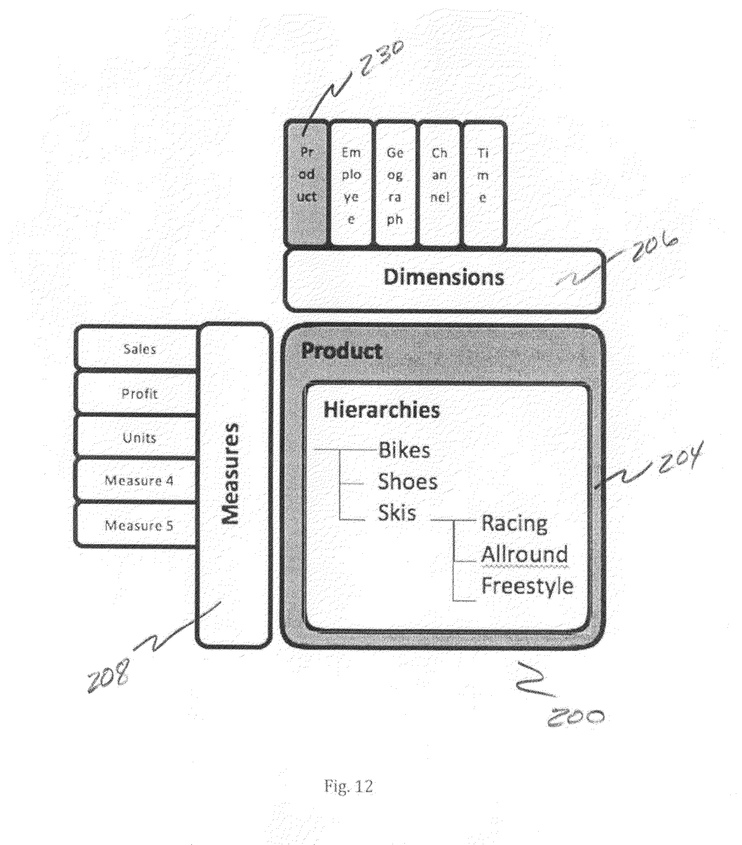

In another exemplary embodiment seen in FIGS. 11 and 12, the present invention can be used with multi-dimensional analytical databases commonly used in modern data analysis. These types of databases introduce large numbers of data tables that are available via multidimensional “cubes.” When working with such multi-dimensional databases, the concepts of “rows” and “columns” may not be appropriate, so the user interface tool 200 may substitute the concept of “dimensions” 206 and “measures.” 208 Using these concepts, the user can control how they define multi-dimensional queries and effectively flatten multi-dimensional databases into more easily managed two-dimensional data sheets or tables.

In an exemplary embodiment of such a user interface tool 200, the “dimensions” data sets 206 are arrayed above the central display box 204 and the “measures” data sets 208 are displayed to the left side of the central display box 204. Both dimensions and measures data sets are usually organized in the form of various levels and hierarchies, and thus direct use of either does not clearly define the portion of the database that is sought by the user. If a user simply drags and drops a specific dimension's component, usually top level information is applied on the target application.

To allow for access to sub-sets of a particular measure or dimension, the user interface tool 200 may display data hierarchies associated with the selected tab 230 in the central display box 204. The user can then select a particular hierarchy or hierarchies for use. These selected sub-sets of the data set can then be dragged and dropped like any other data set. This same type of access to hierarchies and levels is also available for both measures and dimensions.

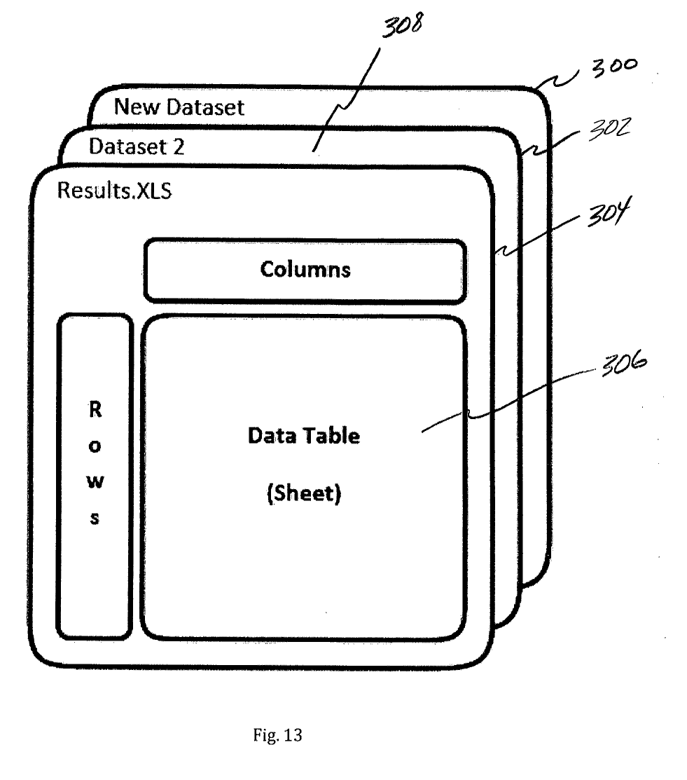

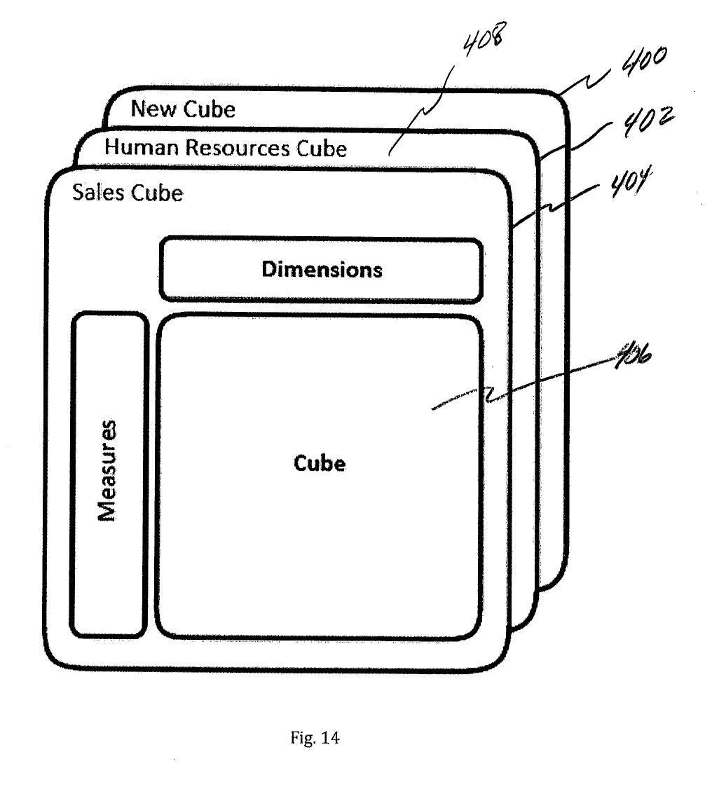

Data analysts also frequently work with multiple data sources at the same time. In an exemplary embodiment, the user interface tool enables a user to quickly switch between different databases. Referring to FIGS. 13 and 14, each database is represented by its own user interface tool 300, 302, 304, 400, 402, 404 with its own central display box 306, 406 and defined components. By clicking an outer display area 308, 408 surrounding the central display box and defined components, the user can select which database they would like to access and bring the user interface tool for that database to the front. If the total number of datasets exceeds a reasonable threshold, then it may be useful to use the same approach as with the situation with too many columns, by limiting the total number of datasets low and provide support for browsing to the next/previous/first/last dataset.

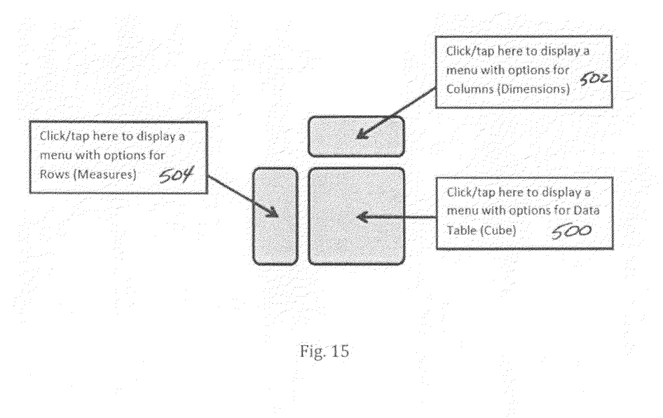

In an exemplary embodiment, the user interface tool is adapted for use on a small screen such as that of a smartphone, netbook, PDA's, tablet or other mobile device, or when a user has only a small part of a document available for the chart or report that is being worked on with the user interface tool. If the user interface tool detects it has only a limited screen space available, it automatically switches to a small-screen mode. Referring to FIG. 15, in this mode, the entire user interface tool is rendered in a small, simplified form, providing just a few main active components representing the data table 500, columns 502 and rows 504, or cube, dimensions, and measures if working in a multi-dimensional database. When the user clicks with a pointing device or taps the screen with his fingers, the system will display a context-based menu. When the user clicks on the columns tab 502 for example, a menu that lists all columns and other column-related options is provided. When user hits rows 504, a menu with row-related options is provided.

Users living in regions with different language or cultural norms may modify the user interface tool or layout to be more consistent with their standards, such as modifying the layout to read from right to left, etc. When in international and globalized applications the user interface tool must respect local language and cultural norms to be fully effective. Accordingly, the user interface tool can be customized by the user, who can essentially define his own configuration.

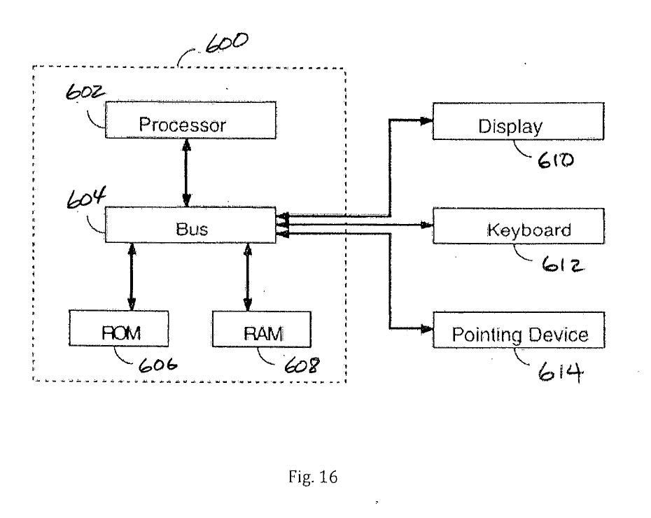

The software that uses the user interface tool described herein should be designed to make as much as use of the information as possible. The user interface tool described above may be implemented on a wide variety of computer or electronic devices that conventionally employ graphical user interfaces. Although the invention is not limited to any particular hardware system, a system used for a typical implementation is shown in FIG. 16. A computer 600 includes a central processing unit 602, data bus 604, ROM 606, and RAM 608. The system also includes I/O devices such as a visual display 610, a keyboard 612, and a pointing device 614. As is the case with other graphical user interface controls, the user interface tool of the present invention is typically stored as computer instruction code in the RAM 608 or ROM 606 for execution by the processor 602. The particular type of code will typically depend on the specific processor used, although the code may be machine-independent code that is executed by a virtual machine running on the processor. In a preferred embodiment, the code takes the form of an executable module that is part of a code library, so that the module is available for use by a number of diverse applications. Based on the detailed description provided above, the user interface tool can be implemented using standard techniques and commercial software development tools. For example, the present invention may be implemented using the C++ programming language, Java script, or DHTML scripts. The invention is expected to be particularly useful in the case of user interface tools commonly used in web browser application programs, database programs, and other programs that benefit from intuitive user interfaces.

One of ordinary skill in the art will now appreciate that the present invention provides a method and system for providing improved controls in a graphical user interface. Although the present invention has been shown and described with reference to a preferred embodiment, equivalent alterations and modifications will occur to those skilled in the art upon reading and understanding this specification. The present invention includes all such equivalent alterations and modifications and is limited only by the scope of the following claims.

What is claimed is:

1. A user interface tool for use on a user display comprising:
a central display box for displaying information relating to some or all of a data set based on the user's selections;
a plurality of tabs corresponding to portions of the data set positioned adjacent to the central display box, whereby information relating to the portion of the data set corresponding to that tab is displayed in the central display box when one of the tabs is selected by the user; and
whereby the user can transfer the portion of the data set corresponding to the selected tab to a target graphic on the user display.

2. The user interface tool of claim 1, wherein the plurality of tabs includes tabs corresponding to the columns of data in the data set.

3. The user interface tool of claim 1, wherein the plurality of tabs includes tabs corresponding to the rows of data in the data set.

4. The user interface tool of claim 1, wherein the plurality of tabs includes tabs corresponding to a user defined portion of the data set.

5. The user interface tool of claim 1, wherein the plurality of tabs includes tabs corresponding to a pre-defined portion of data in the data set.

6. The user interface tool of claim 1, wherein the tabs are labeled to identify the corresponding portion of the data set.

7. The user interface tool of claim 1, wherein the plurality of tabs includes tabs corresponding to the dimensions of a multidimensional database.

8. The user interface tool of claim 1, wherein the plurality of tabs includes tabs corresponding to the measures of a multidimensional database.

9. The user interface tool of claim 1, wherein the plurality of tabs includes tabs corresponding to hierarchies of data in a multidimensional database.

10. The user interface tool of claim 9, wherein the hierarchies of multidimensional data are displayed in the central display box.

11. The user interface tool of claim 10, wherein the user can select from the hierarchies displayed in the central display box.

12. The user interface tool of claim 1, wherein the target graphic is a chart.

13. The user interface tool of claim 1, wherein the target graphic is a graph.

14. The user interface tool of claim 1, wherein the target graphic is a spreadsheet.

15. The user interface tool of claim 1, wherein the target graphic is a database report.

16. The user interface tool of claim 1, wherein the target graphic is a database development tool.

17. The user interface tool of claim 1, wherein the target graphic is a database management tool.

18. The user interface tool of claim 1, wherein the position of the tabs is based on the logical disposition of data tables and spreadsheets.

19. The user interface tool of claim 1, wherein the user can identify a portion of a dataset further used in an application by selecting its associated tab.
